(19) United States
(12) Patent Application Publication
(10) Pub. No.: US 2010/0108433 A1
(43) Pub. Date: May 6, 2010

(54) ELECTROACOUSTIC TRANSDUCER DIAPHRAGM

(75) Inventors: Koji Takayama, Yamagata (JP); Masatoshi Sato, Yamagata (JP); Shinichi Hayasaka, Yamagata (JP); Hiroyuki Kobayashi, Yamagata (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION, Tokyo (JP); TOHOKU PIONEER CORPORATION, Yamagata (JP)

(21) Appl. No.: 12/683,769

(22) Filed: Jan. 7, 2010

Related U.S. Application Data
(63) Continuation of application No. 11/128,232, filed on May 13, 2005.

(30) Foreign Application Priority Data
May 13, 2004 (JP) 2004-144146

(51) Int. Cl. H04R 7/00

(52) U.S. Cl. 181/169; 181/170

(57) ABSTRACT

A method for manufacturing an electroacoustic transducer diaphragm of a multilayered structure which includes a first diaphragm layer made from a synthetic resin material and molded into a predetermined shape through injection molding, and a second diaphragm layer laminated in close contact with the first diaphragm layer and made from a material differing from that of the first diaphragm layer, the method includes inserting the second diaphragm layer into a mold for injection molding, and forming the first diaphragm layer integrally with the second diaphragm layer by injection foam-molding within the injection mold.

### CROSS REFERENCE TO RELATED APPLICATIONS

This is a continuation of application Ser. No. 11/128,232 filed May 13, 2005, which claims benefit of Japanese Application No. 2004-144146 filed May 13, 2004, the entire disclosure of which is incorporated herein by reference.

### BACKGROUND OF THE INVENTION

1. Field of the Invention

The present invention relates to a method for manufacturing an electroacoustic transducer diaphragm, and particularly to a method for manufacturing an electroacoustic transducer diaphragm of a multilayered structure including a first diaphragm layer made from a synthetic resin and molded into a predetermined shape through injection molding, and a second diaphragm layer (a skin layer) laminated on the first diaphragm layer in close contact therewith and made from a material different from that of the first diaphragm layer.

2. Description of the Related Art

Properties required of a diaphragm for an electroacoustic transducer, such as a speaker or a microphone, include a large specific modulus (E/ρ), a large specific flexural rigidity (E/ρ³), and an appropriate internal loss, as well as high resistance to mechanical fatigue and weathering. In addition, in recent years, waterproofness has become an essential property, particularly for an electroacoustic transducer diaphragm to be mounted on a vehicle.

In light of these desires, a variety of materials including metals, ceramics, synthetic resins, synthetic fibers, natural cellulose fibers, and, recently, microbial cellulose fibers produced by use of biotechnology have been proposed, and processed with use of a variety of processing methods and put into practice.

However, each of the materials has its own inherent characteristics, which result in advantages and disadvantages in terms of properties required of a diaphragm. Therefore, in actual practice, causing a diaphragm formed from a single material to exhibit a number of properties required of a diaphragm in good balance encounters significant difficulty.

For instance, a so-called paper diaphragm made from cellulose fibers such as wood pulp has advantages of being comparatively lightweight, having an appropriate elastic modulus and an appropriate internal loss, and, in addition, being capable of made by means of a variety of manufacturing methods, thereby exhibiting a high degree of flexibility in design. On the other hand, the paper diaphragm has disadvantages of involving difficulty in ensuring waterproofness, and difficulty in increasing elastic modulus for the purpose of ensuring a large maximum power input.

In contrast, a diaphragm made from a synthetic resin, that made from a metal, or the like, has advantages of waterproofness being easily ensured and high elasticity being easily imparted for the purpose of ensuring a large maximum power input. On the other hand, such a diaphragm has disadvantages of having a high density and a small internal loss (although some resins have large internal losses). Therefore, such a diaphragm is not necessarily optimum for use in low to middle frequency ranges or overall frequency ranges where a diaphragm must be lightweight and highly rigid.

To this end, there has been proposed manufacture of a well-balanced diaphragm by means of adopting a multilayered structure constituted of a plurality of materials possessing different properties, thereby compensating for disadvantages of the respective materials.

FIG. 1 shows an example of such an electroacoustic transducer diaphragm.

An electroacoustic transducer diaphragm 1 shown in FIG. 1 includes a first diaphragm layer 3 formed from a synthetic resin and molded into a predetermined shape through injection molding, and a second diaphragm layer (a skin layer) 5 laminated on the first diaphragm layer 3 in close contact therewith and formed from a material different from that of the first diaphragm layer 3.

When, for instance, woven fabric of aramid fibers is used as a material of the second diaphragm layer 5, disadvantages of the woven fabric of aramid fibers are compensated by characteristics of the resin layer, thereby enabling production of a diaphragm having a larger number of properties in good balance.

Meanwhile, the method having already been disclosed as a method for manufacturing the electroacoustic transducer diaphragm 1 having such a multilayered structure includes forming the second diaphragm layer 5 into predetermined dimensions and a predetermined shape in advance by means of a press-molding machine, or the like, and subjecting the thus-formed second diaphragm layer 5 to insert molding at the time of formation of the first diaphragm layer 3, thereby integrating the second diaphragm layer 5 with the first diaphragm layer 3 (see, e.g., JP-A-2000-4496).

However, according to the related-art manufacturing method, when the thickness of the first diaphragm layer 3 formed by means of injection molding is reduced to a minimum required thickness for weight reduction, the reinforcing effect for compensating for a deficiency in the rigidity of the diaphragm made from woven fabric of fibers is lost. For this reason, when an attempt is made to increase the amount of resin material to be injected (the amount of resin material for filling) to increase the thickness of the first diaphragm layer 3, the rigidity is enhanced, and sound quality in a low tone range can be enhanced. In the meantime, there arises a problem of an increase in weight and deterioration of light-weight high rigidity.

Problems that the present invention is to solve include, for example, the following problem which arises in the above-mentioned related art. When the amount of resin to be filled is increased for imparting the reinforcing effect for causing the first diaphragm layer to compensate for a deficiency in the rigidity of the second diaphragm layer, the diaphragm becomes heavy, thereby raising, as an example, a problem of deterioration of light-weight high-rigidity required for the diaphragm of the speaker.

### SUMMARY OF THE INVENTION

According to an aspect of the present invention, a method for manufacturing an electroacoustic transducer diaphragm of a multilayered structure which includes a first diaphragm layer made from a synthetic resin material and molded into a predetermined shape through injection molding, and a second diaphragm layer laminated in close contact with the first diaphragm layer and made from a material differing from that of the first diaphragm layer, the method includes inserting the second diaphragm layer into a mold for injection molding, and forming the first diaphragm layer integrally with the second diaphragm layer by injection foam-molding within the injection mold.

### BRIEF DESCRIPTION OF THE DRAWINGS

FIG. 1 is a longitudinal cross-sectional view showing a configuration of an electroacoustic transducer diaphragm of multilayered structure;

FIG. 2 is a block diagram showing a schematic configuration of an injection molding machine for use in an embodiment of a method for manufacturing an electroacoustic transducer diaphragm according to the invention;

FIG. 3 is a longitudinal cross-sectional view of an open state of an injection mold for use in the injection molding machine shown in FIG. 2;

FIG. 4 is a view taken in the direction of an arrow A in FIG. 3;

FIG. 5 is an explanatory view of a sheet material for a second diaphragm layer of the diaphragm according to the embodiment of the invention;

FIG. 6 is an explanatory view of a state where a not-yet-molded sheet material which is a raw material of the second diaphragm layer is attached to one mold half of the injection mold shown in FIG. 3;

FIG. 7 is a view taken in the direction of an arrow B in FIG. 6;

FIG. 8 is a cross-sectional view showing a process where the not-yet-molded sheet material is being formed into a predetermined shape in the embodiment of the invention;

FIG. 9 is cross-sectional view showing an initial state where a synthetic resin material to be formed into the first diaphragm layer is injected into the injection mold in the embodiment of the invention;

FIGS. 10A to 10C are explanatory views showing a procedure of injection foam-molding according to the embodiment of the invention;

FIG. 11 is an explanatory view showing changes, between a pre-foamed state and a post-foamed state, in the structure of a synthetic resin injected into the injection mold in the embodiment of the invention;

FIG. 12 is a longitudinal cross-sectional view of a molded product formed through the injection foam-molding shown in FIG. 10; and

FIGS. 13A to 13F are explanatory views showing, in the embodiment of the method for manufacturing the electroacoustic transducer diaphragm according to the invention, a procedure where the injection foam-molding process is performed with two pieces of second diaphragm layers having been formed in advance inserted in the injection mold.

### DETAILED DESCRIPTION OF THE INVENTION

Hereinafter, a method for manufacturing an electroacoustic transducer diaphragm according to a preferred embodiment of the invention will be described in detail by reference to the drawings.

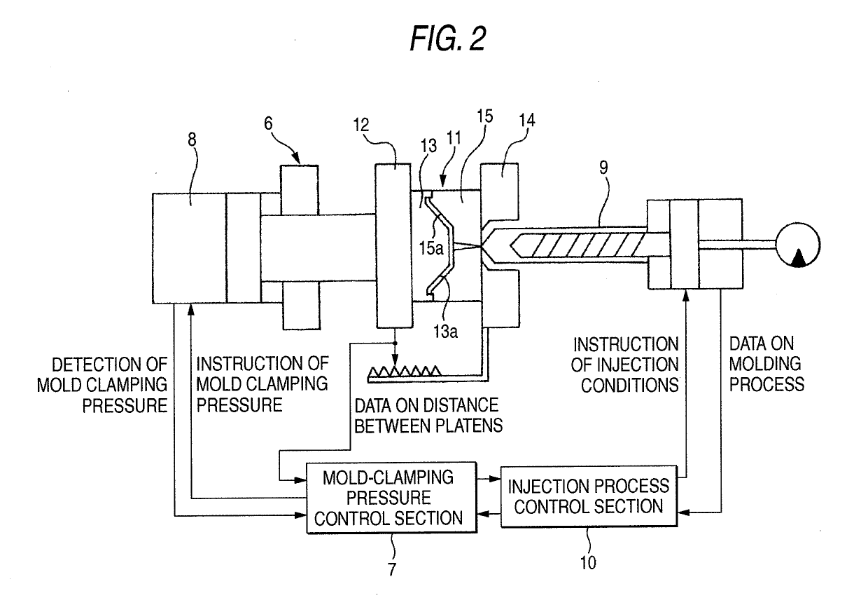

FIG. 2 is a block diagram showing a schematic configuration of an injection molding machine for use in an embodiment of a method for manufacturing an electroacoustic transducer diaphragm according to the invention.

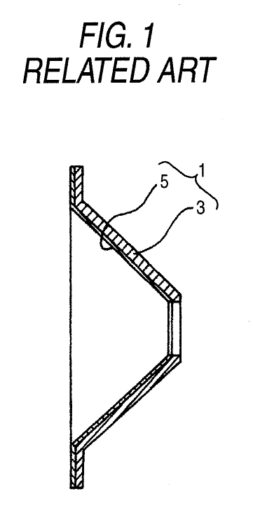

An injection mold 11 of an injection molding machine 6 shown in FIG. 2 is a mold for manufacturing an electroacoustic transducer diaphragm 1 shown in FIG. 1. The injection mold 11 includes a male mold 13 having a conical protruding section 13a along the contour of the surface of the electroacoustic transducer diaphragm 1, and a female mold 15 having a conical recessed section 15a corresponding to the conical protruding section 13a.

In the present embodiment, the male mold 13 is actuated as a movable mold while being held by a movable platen 12. The female mold 15 is actuated as a fixed mold while being held by a fixed platen 14.

A clamping pressure between the male mold 13 and the female 15 is controlled by a clamping cylinder 8 which is controlled by a mold clamping pressure control section 7.

A nozzle (a gate) 25 through which a synthetic resin is ejected is formed at a center section of the female mold 15 so as to pierce the center section. An injection nozzle of an injection unit 9 is inserted into the gate 25. The injection unit 9 is a device for injecting a resin mixture obtained by means of mixing an olefin resin, such as PP (polypropylene), serving as a base material, with a foaming agent and an organic or inorganic filler.

The injection unit 9 is controlled in accordance with an injection condition which is controlled by an injection process control section 10. In addition, data on the molding process are output from the injection unit 9 side. The mold clamping pressure control section 7 controls a mold clamping pressure on the basis of the thus-output data, data on a distance between the movable platen 12 and the fixed platen 14, and the like.

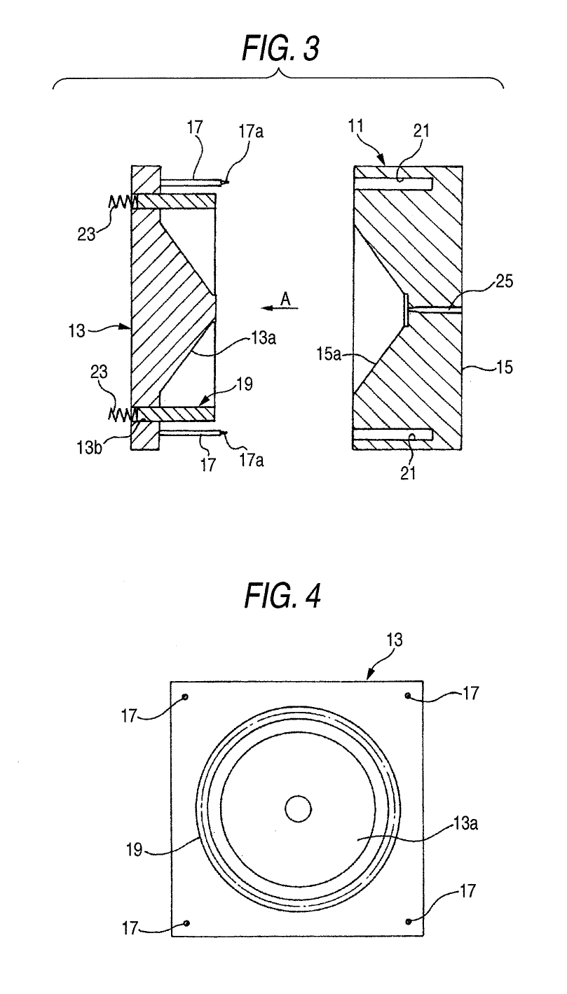

In the present embodiment, as shown in FIG. 3, the male mold 13 includes four sheet positioning pins 17 and a sheet-press unit 19. A needle 17a at a tip of each of the sheet positioning pins 17 pierces through a peripheral section of a sheet material, which will be described layer, to thus anchor the sheet material in place. The sheet-press unit 19 presses the surface of the sheet material positioned by the sheet positioning pins 17, thereby preventing occurrence of wrinkles on the sheet material.

As shown in FIG. 3, the sheet positioning pins 17 are disposed upright at four corners of an abutting face of the male mold 13 opposing the female mold 15.

Clearance holes 21 in which the sheet positioning pins 17 are to be inserted are formed in the abutting face of the female mold 15 opposing the male mold, so as to prevent the sheet positioning pins 17 from interfering with the female mold 15 at the time of mold clamping.

As shown in FIG. 3, the sheet-press unit 19 is of a cylindrical shape whose center axis coincides with the conical protruding section 13a. The sheet-press unit 19 is slidably supported on the female mold 15 by means of guide holes 13b disposed in the male mold 13, and is tensioned toward the female mold 15 by means of a tensioning unit (springs) 23 disposed at the rear ends of the guide holes 13b.

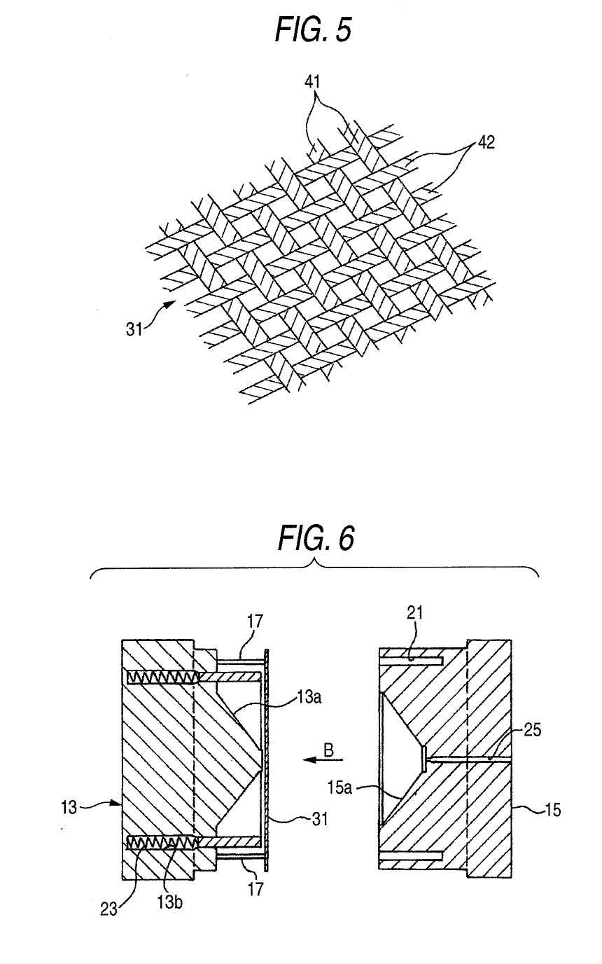

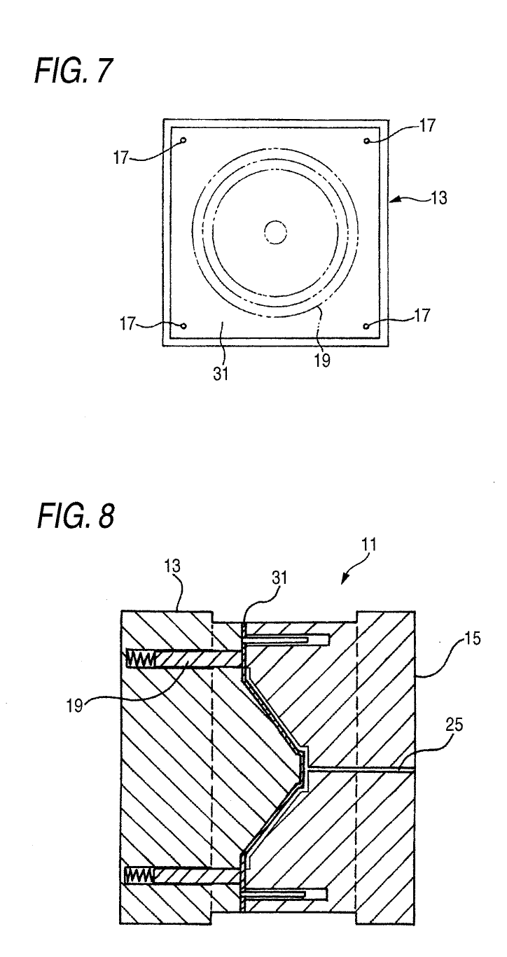

In the present embodiment, the second diaphragm layer 5 is constructed by means of forming a sheet-like material 31 shown in FIG. 5 into a predetermined diaphragm shape. In the present embodiment, as shown in FIG. 5, the sheet-like material 31 is woven fabric wherein two fibers constituting a warp 41 and a weft 42 are woven by means of a biaxial weave (a plain weave).

In addition, in the present embodiment, the sheet-like material 31 is woven fabric of aramid fibers using aromatic polyamide fibers as the respective fibers 41 and 42. More specifically, woven fabric of Kevlar K144 manufactured by DU PONT-TORAY CO., LTD. (weight of warp and weft: 400 denier, a plain weave wherein a warp and a weft is each formed from 30 filaments).

However, the woven fabric constituting the sheet-like material 31 is not limited to the woven fabric of aramid fibers. For instance, woven fabric of carbon fibers, or those of any of a variety of known fibers can be employed.

In addition, the weave structure of the woven fabric is not limited to the plain weave.

Next, a method for forming the sheet-like material 31 made from woven fabric into a predetermined diaphragm shape will be described.

First, as shown in FIG. 6, a not-yet-molded sheet-like material 31, which is a raw material of the second diaphragm layer, is attached to the sheet positioning pins 17 of the mold 13 in a state where the respective mold halves 13 and 15 of the injection mold 11 are open.

Subsequently, a pre-forming process is performed. In the pre-forming process, as shown in FIG. 8, by means of clamping the injection mold 11, the sheet-like material 31 is held between the conical protruding section 13a and the conical recessed section 15a. As a result, a predetermined diaphragm shape is imparted to the sheet-like material 31.

Subsequently, an injection molding process is performed for forming the first diaphragm layer 3. Meanwhile, as shown in FIG. 9, injection molding may be performed as follows. The male mold 13 is moved by a predetermined distance from a mold-clamped state shown in FIG. 8 in a direction where the mold halves separate from each other, thereby forming a mold gap S for facilitating flow of the resin. Thereupon, a process of clamping the mold gap S again during the course of injection is added.

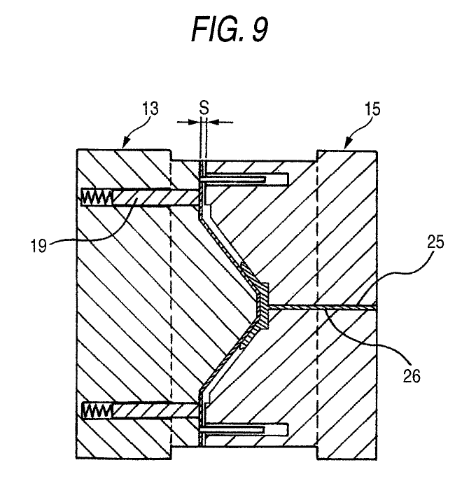

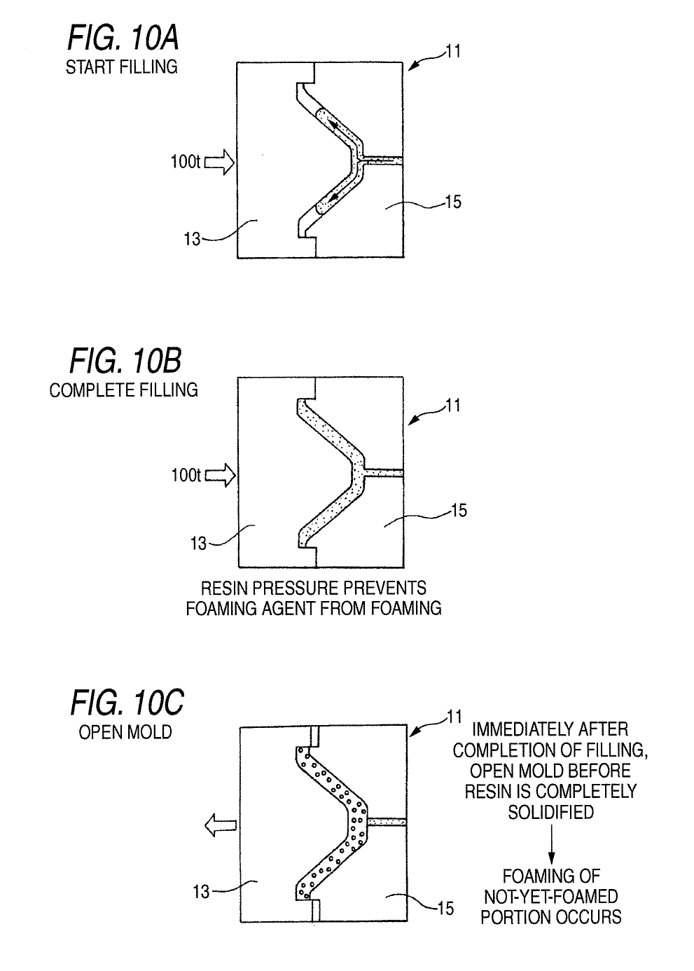

Next, an injection foam-molding process for foaming the first diaphragm layer 3 will be described by reference to FIGS. 10A to 10C.

First, a mold-clamping mechanism of the injection molding machine 6 adjusts a clearance between the male mold 13 and the female mold 15 of the injection mold 11 to an injection molding state shown in FIG. 9. Thereafter, as shown in FIG. 10A, a resin mixture of PP (polypropylene) mixed with a foaming agent and an organic or inorganic filler is ejected from the injection unit 9.

At this time, the temperature of the resin mixture within the injection unit 9 is maintained at about 230° C. In addition, the temperature of a cavity face in the injection mold 11 is maintained at about 90° C. Furthermore, the mold-clamping cylinder 8, which is controlled by the mold clamping pressure control section 7, maintains the clamping pressure at about 100 t. Still furthermore, the general thickness of the cavity formed by the male mold 13 and the female mold 15 of the injection mold 11 is set to about 0.2 mm.

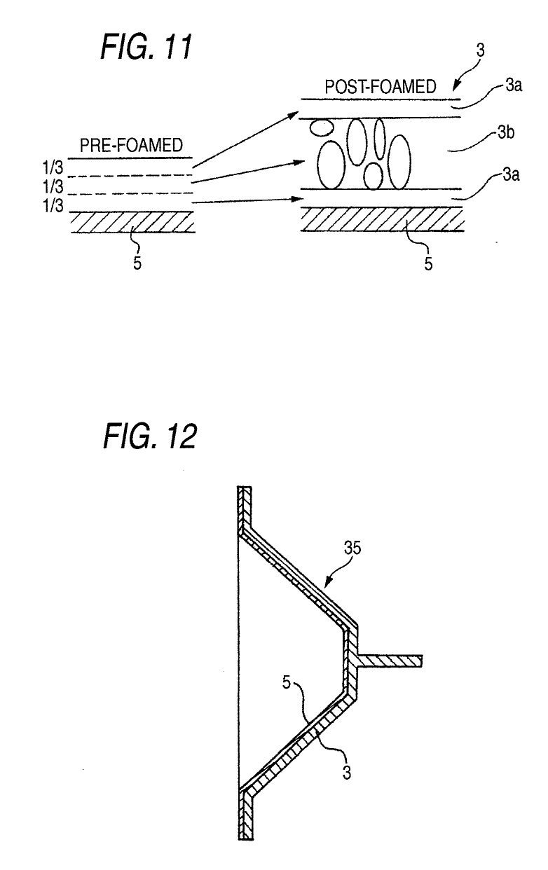

At this time, as shown in FIG. 10B, solidification of the resin mixture filled in the cavity between the male mold 13 and the female mold 15 begins from a portion in contact with the injection mold 11 or with the second diaphragm layer 5. The thus-solidified outer surface layer forms skin layers 3a as shown in FIG. 11. Pressure exerted by extrusion of the resin mixture out of a screw of the injection unit 9 and a clamping pressure from the male mold 13 and the female mold 15 are applied to the remaining melt portion. Accordingly, gas generated by decomposition of the foaming agent is compressed, whereby solidification proceeds while foaming is suppressed.

Subsequently, as shown in FIG. 10C, immediately after completion of injection of the resin mixture and while a foaming pressure of the foaming agent within the melt portion is still sufficient for expanding the surrounding skin layer (solidified portion) 3a, a clamping pressure applied by the mold-clamping cylinder 8—under control by the mold-clamping pressure control section 7—is caused to drop instantaneously to about 0 t. As a result, the decomposed gas of the foaming agent of the melt portion, which has been compressed, inflates while expanding the surrounding resin, to thus start foaming. Accordingly, as shown in FIG. 11, a foam layer 3b sandwiched between the skin layers 3a is formed.

Hereinbelow, a timing to open the male mold 13 will be described. When the mold is opened before completion of resin injection, excessive resin mixture is injected inside the cavity between the male mold 13 and the female mold 15, thereby undesirably increasing the weight of the product. In contrast, when a timing to open the mold is too late, solidification of the resin proceeds to an excessive degree, whereby the resin is completely solidified while the foaming agent remains incapable of foaming. Therefore, the mold is preferably opened at a timing of 0.3 to 0.4 second after start of injection. However, the above requirements will be changed depending on conditions, such as the temperature of the resin mixture, the temperature of the injection mold 11, product thickness, addition amount of the foaming agent, and the like.

The injection mold 11 is to be opened by a distance of about 0.1 to 1.5 mm at high speed, that is, within a time period of 0.04 to 0.05 second. Therefore, a platen opening force and platen clamping pressure are controlled so that the injection mold 11 is opened at a speed of about 0.0020 to 0.0375 mm/ms. A speed of about 0.001 mm/ms or faster is sufficient for molding of a low-profile foam-molded diaphragm.

Specific examples of the injection molding machine 6 and foaming agent adopted in the embodiment will be described hereinbelow. PP (polypropylene) consists of MA06 (manufactured by Mitsubishi Chemical Corporation) to which 7% of carbon fiber is added. The foaming agent consists of EE-205 (manufactured by Eiwa Chemical Ind. Co., Ltd.), and was added in an amount of 0.1 part by weight. As the injection molding machine 6, Ultra 220 (manufactured by Sumitomo Heavy Industries, Ltd.) was employed.

FIG. 12 shows a molded product 35 ejected from the injection mold 11 having been opened after completion of the injection foam-molding process.

By means of removing unnecessary portions (e.g., a gate mark) from the molded product 35, there can be obtained an electroacoustic transducer diaphragm of a multilayered structure in which the second diaphragm layer 5 is laminated on the first diaphragm layer 3 in close contact therewith as shown in FIG. 1.

According to the manufacturing method described in the embodiment, the first diaphragm layer 3 integrated with the second diaphragm layer 5 through insert molding has a layered structure containing therein bubbles generated as a result of injection foam-molding. The first diaphragm layer 3 formed by means of the injection foam-molding is subjected to a reduction in specific gravity and an increase in thickness with an increase in expansion ratio, even when the amount of resin filled into the mold remains constant. Accordingly, rigidity is enhanced.

Therefore, by means of adequately adjusting the expansion ratio at the time of injection foam-molding and without increasing the filling amount of resin to be formed into the first diaphragm layer 3 at the time of insert molding, sufficient rigidity of the first diaphragm layer 3 can be ensured. Therefore, a lightweight and highly rigid diaphragm which is required for reproduction of the overall frequency range can be obtained easily.

In the above-described method for manufacturing the electroacoustic transducer diaphragm, the second diaphragm layer 5 to be inserted in the injection mold is woven fabric. Accordingly, since the synthetic resin material, which forms the first diaphragm layer 3 and which is filled in the mold at the time of insert molding, impregnates interstices of the fibers constituting the woven fabric, an extremely high adhesive strength can be obtained without use of an adhesive film or the like.

More specifically, even when properties of the first diaphragm layer 3 and the second diaphragm layer 5—which are to be laminated—differ significantly, a sufficient adhesive strength can be ensured between the diaphragm layers 3 and 5 even without an attempt to increase the adhesive strength through use of an adhesive film or the like during insert molding.

Accordingly, a process of affixing an adhesive film on the surface of the second diaphragm layer 5 to be inserted in the injection mold 11, or the like, is negated, thereby simplifying the injection foam-molding process, to thus save manufacturing cost. In addition, a degree of freedom in selection of materials for use in the respective diaphragm layers 3, 5 is increased, thereby enabling full use of merits of the multilayered structure constituted of different types of materials.

In addition, according to the embodiment, the molding process of the second diaphragm layer 5 is not performed by a dedicated press forming machine, or the like, but by means of being pinched between the mold halves of the injection mold 11 for manufacturing the first diaphragm layer 3, followed by the injection molding process for manufacturing the first diaphragm layer 3. Accordingly, the number of manufacturing processes is reduced as compared with that of a manufacturing method of the related art in which the second diaphragm layer 5 is independently formed in another manufacturing line. As a result, cost can be saved.

In relation to the above, the not-yet-molded sheet-like material 31 is subjected to pre-forming to thus be formed into a predetermined shape through mold clamping of the injection mold 11, and is thereafter accurately press-formed into the shape of the cavity of the mold by means of resin pressure and heat applied at the time of injection molding. Accordingly, faulty adhesion caused by a dimensional error, and the like, does not occur between the thus-molded first diaphragm layer 3 and the second diaphragm layer 5.

Therefore, uniform, close contact can be achieved throughout the region of laminated face of the first diaphragm layer 3 and the second diaphragm layer 5. This equalization of adhesiveness between the diaphragm layers ensures uniformity of properties throughout the region of the diaphragm. As a result, properties having been improved by virtue of a multilayered structure constituted of different types of materials can be ensured uniformly throughout the diaphragm, thereby enabling stable enhancement of acoustic absorption characteristics.

In addition, according to the method for manufacturing the electroacoustic transducer diaphragm of the embodiment, mold clamping can be performed in a state where the sheet positioning pins 17 and the sheet-press unit 19 apply appropriate tension on the sheet-like material 31 which is attached to the abutting face of the mold half 13, to thus prevent occurrence of wrinkles on the sheet-like material 31. Accordingly, faulty molding of the sheet material during the course of the pre-forming process is suppressed, whereby the pre-forming process can be performed smoothly.

Furthermore, according to the manufacturing method of the embodiment, after mold clamping for the pre-forming process, the mold half 13 is caused to move by a predetermined distance in the direction where the mold halves separate from each other, to thus form the gap S so that the synthetic resin material 26 can flow smoothly at the time of injection. As a result, flow stress can be lowered, thereby enabling prevention of displacement wrinkles, deformation, and the like, of the sheet material having been pre-formed through mold clamping.

Meanwhile, the above embodiment has described the case where the electroacoustic transducer diaphragm 1 to be manufactured is of a conical shape. However, the invention can also be applied to manufacturing of a dome-type diaphragm of multilayered structure.

The sheet-like material 31 which is to become the second diaphragm layer is not limited to the woven fabric described in connection with the embodiment. Nonwoven fabric can also be used. Alternatively, for instance, so-called cone paper using as principal material cellulose fibers, such as wood pulp or the like, can also be used as the sheet-like material 31.

A material made by mixing olefin-based resin, such as polypropylene, with a filler such as mica or carbon fibers is used as the synthetic resin material used for forming the first diaphragm layer 3.

Meanwhile, the above embodiment has assumed that the second diaphragm layer 5 is formed such that the not-yet-molded sheet-like material 31 is press-formed into a predetermined diaphragm shape through mold clamping of the injection mold 11. Alternatively, the second diaphragm layer 5 may be formed as follows. That is, the second diaphragm layer 5 is formed by means of another forming machine, or the like, in advance, and injection foam-molding is performed with the thus-formed second diaphragm layer 5 inserted in the injection mold 11.

In addition, the above embodiment has been described in terms of a diaphragm of two-layer structure constructed such that the second diaphragm layer 5 is laminated on one face of the first diaphragm layer 3. However, the electroacoustic transducer diaphragm of the invention may be of a three-layer structure constructed such that the second diaphragm layer 5 is laminated on each of the two faces of the first diaphragm layer 3.

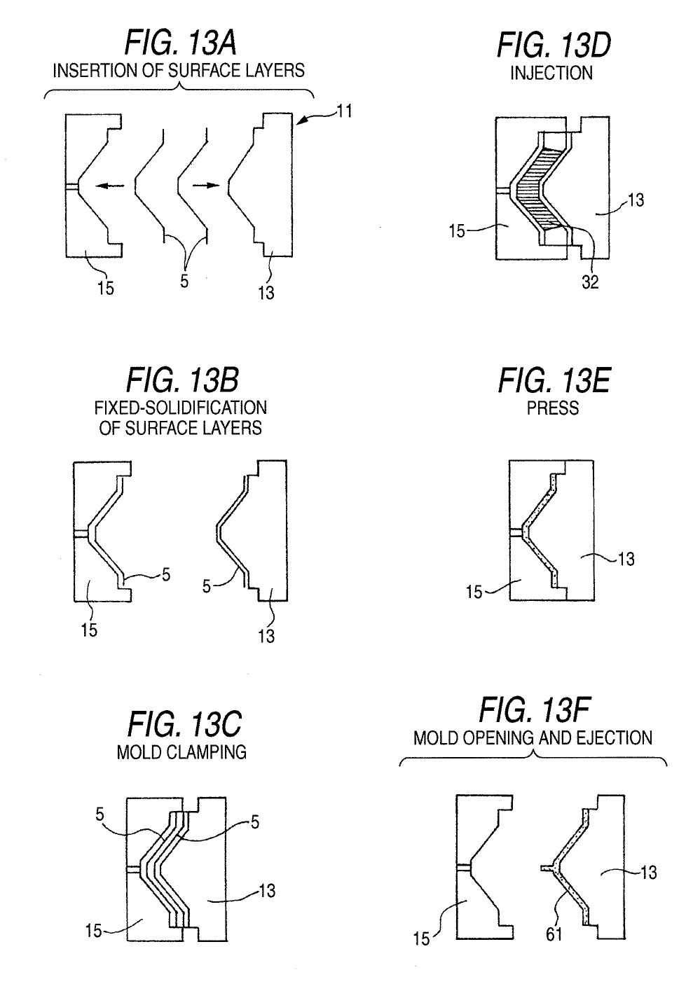

FIGS. 13A to 13F are views showing a procedure where the injection foam-molding process is performed by means of inserting in the injection mold 11 two pieces of second diaphragm layers 5 having been formed in advance.

First, as shown in FIG. 13A, the male mold 13 and the female mold 15 are set in an open state. The second diaphragm layers 5 having been formed in advance are respectively fixed on the surface of each of the mold halves 13 and 15 as shown in FIG. 13B. The second diaphragm layers 5 may be fixed to the respective molds 13, 15 by means of vacuum suction rather than by means of the sheet positioning pins 17 and the sheet-press unit 19 shown in the above-described embodiment.

Subsequently, as shown in FIG. 13C, the mold is clamped once. Thereafter, as shown in FIG. 13D, clearance between the molds 13 and 15 is adjusted, and the clearance is filled with a resin mixture 32 obtained by means of mixing an olefin resin, such as PP (polypropylene), serving as a base material, with a foaming agent and an organic or inorganic filler. At the time of filling of the resin mixture 32, the filled resin mixture 32 can be caused to uniformly spread over the cavity by means of actuating a press unit, to thus slightly clamp the mold halves 13 and 15 as shown in FIG. 13E. Thereafter, the mold halves 13 and 15 are opened to an appropriate extent, thereby inducing foaming of a not-yet-solidified layer of the filled resin.

When the mold halves 13 and 15 are opened upon completion of the injection foam-molding process as shown in FIG. 13F, there can be obtained a diaphragm 61 of multilayered structure in which the second diaphragm layers 5 are integrally laminated on each side of the first diaphragm layer 3 of a foamed-resin structure.

As described above in detail, the method for manufacturing an electroacoustic transducer diaphragm according to the embodiment of the invention is a method for manufacturing an electroacoustic transducer diaphragm of multilayered structure which includes the first diaphragm layer 3 made from a synthetic resin material and molded into a predetermined shape through injection molding, and a second diaphragm layer (skin layer) 5 laminated on the first diaphragm layer 3 in close contact therewith and made from a material different from that of the first diaphragm layer 3. The method includes inserting the second diaphragm layer 5 into a mold for injection molding, and forming the first diaphragm layer 3 integrally with the second diaphragm layer 5 by injection foam-molding within the injection mold.

Accordingly, the first diaphragm layer 3 integrated with the second diaphragm layer 5 through insert molding has a layered structure containing therein bubbles generated as a result of injection foam-molding. The first diaphragm layer 3 formed by means of the injection foam-molding is subjected to a reduction in specific gravity and an increase in thickness with an increase in expansion ratio, even when the amount of resin filled into the mold remains constant. Accordingly, rigidity is enhanced.

Therefore, by means of adequately adjusting the expansion ratio at the time of injection foam-molding and without increasing the filling amount of resin to be formed into the first diaphragm layer 3 at the time of insert molding, sufficient rigidity of the first diaphragm layer 3 can be ensured. Therefore, a generation of deformation arising from difference between shrinkage ratios of dissimilar materials can be prevented, and a lightweight and highly rigid diaphragm which is required for reproduction of the low to middle frequency range or overall frequency range can be obtained easily.

What is claimed is:

1. An electroacoustic transducer diaphragm, comprising:
a first diaphragm layer, including three layers of a synthetic resin material, the three layers including two solid layers and a foaming layer disposed between the solid layers; and
a second diaphragm layer, laminated on the first diaphragm layer and including one layer of fibers.

2. The electroacoustic transducer diaphragm according to claim 1, wherein
each of the three layers of the first diaphragm layer includes a form agent.

3. The electroacoustic transducer diaphragm according to claim 1, wherein
each of the three layers of the first diaphragm layer includes a filler.

4. The electroacoustic transducer diaphragm according to claim 1, wherein
a thickness of the foaming layer is larger than a thickness of the solid layer.

5. The electroacoustic transducer diaphragm according to claim 1, wherein
a thickness of the foaming layer is approximately equal to a thickness of the two solid layers.

6. The electroacoustic transducer diaphragm according to claim 1, wherein
the second diaphragm layer includes a woven fabric.

7. The electroacoustic transducer diaphragm according to claim 1, wherein
the second diaphragm layer includes a nonwoven fabric.

8. The electroacoustic transducer diaphragm according to claim 1, wherein
the second diaphragm layer is impregnated with the synthetic resin, and the second diaphragm layer is solidified.

9. The electroacoustic transducer diaphragm according to claim 1, wherein
the second diaphragm layer is laminated on a sound-radiation directional surface of the first diaphragm layer.

10. An electroacoustic transducer diaphragm, comprising:
a first diaphragm layer, including three layers of a synthetic resin material, the three layers including two solid layers and a foaming layer disposed between the solid layers; and
a pair of second diaphragm layers, laminated on the first diaphragm layer and made from fibers.

11. The electroacoustic transducer diaphragm according to claim 10, wherein
each of the three layers of the first diaphragm layer includes a form agent.

12. The electroacoustic transducer diaphragm according to claim 10, wherein
each of the three layers of the first diaphragm layer includes a filler.

13. The electroacoustic transducer diaphragm according to claim 10, wherein
a thickness of the foaming layer is larger than a thickness of the solid layer.

14. The electroacoustic transducer diaphragm according to claim 10, wherein
a thickness of the foaming layer is approximately equal to a thickness of the two solid layers.

15. The electroacoustic transducer diaphragm according to claim 10, wherein
the second diaphragm layer includes a woven fabric.

16. The electroacoustic transducer diaphragm according to claim 10, wherein
the second diaphragm layer includes a nonwoven fabric.

17. The electroacoustic transducer diaphragm according to claim 10, wherein
the second diaphragm layer is impregnated with the synthetic resin, and the second diaphragm layer is solidified.
